(19) United States
(12) Patent Application Publication
(10) Pub. No.: US 2011/0049949 A1
(43) Pub. Date: Mar. 3, 2011

(54) Durable Flame Resistant Seat Cover

(76) Inventors: Joseph F. Basmaji, Waterford, MI (US); David W. McNealy, III, Wyandotte, MI (US)

(21) Appl. No.: 12/875,114

(22) Filed: Sep. 2, 2010

Related U.S. Application Data
(60) Provisional application No. 61/275,671, filed on Sep. 2, 2009.

(51) Int. Cl. B60N 2/60

(52) U.S. Cl. 297/219.1

(57) ABSTRACT

An improved seat covering for use with automotive, truck and other type vehicle seats. Said seat cover of one piece construction for incorporating multiple sewn panels for a custom fit and custom fastening scheme.

More particularly for improved durability against abrasion, excessive wear and tear. Said seat cover providing superior high heat as well as good flame resistant values.

Said seat cover incorporates the back cover, the bottom cover, and side panels that wrap around seat back and secured by a fastening scheme that allows the installer to attached and adjust fasteners primarily made of Velcro strips and straps fastened to the seat carpet and fastened to specific portions of said seat cover.

Said seat cover including accessory pockets on side panel of seat cover for housing a multitude of components not limited to flash light, utility knife, writing pads and utensils just to name a few.

### CROSS-REFERENCE TO RELATED APPLICATION

This application claims the benefit of U.S. Provisional Application 61/275,671, filed Sep. 2, 2009, the entire disclosure of which is hereby incorporated by reference.

### BACKGROUND OF THE INVENTION

1. Field of the Invention

The present invention relates to seat covers for passenger vehicles and more particularly to protective seat covers for use in the drivers and passengers seats of a passenger vehicle.

This present invention is in the technical field of interiors of passenger vehicles, particularly commercial use, utility use and custodial use vehicles which often suffer interior damage, particularly to the seat from multiple wear or abrasion caused by an occupant cycling in and out of a vehicle and wearing a utility belt or occupational component belt for example a Police officer's gun belt.

These component or utility belts often wear holes into the vehicle seat fabric as this imposes additional wear and tear that is above and beyond normal use. More particularly vehicle occupants wearing component or utility type belts can often wear holes through the seat fabric thereby exposing the foam interior, the foam support bar or supporting seat structures.

Damage to the vehicles interior significantly diminished the value of the vehicle and more importantly can impose a hazardous risks to the occupants when the components of a utility belt are caught in the exposed seat structure. For example the radio support housing on a police officer's gun belt is caught in the exposed structural support bar upon exiting the vehicle. This can result in significant risk to the officer if this potential issue occurs in an emergency situation.

Seat covers in commercial use vehicles must also meet all federal vehicle safety guide lines for fire resistant qualities and provide high heat and flame resistant benefits meeting all Federal Vehicle Safety Standard Guidelines, specifically Standard No. 302—Flammability of Interior Materials—Passenger cars, Multipurpose Passenger Vehicles, Trucks, and Buses for application and use.

2. Description of the Prior Art

Seat coverings for automotive use have been available and in use for a number of years. These seat covers provide varying degrees of protection against damage to the original manufacturer's seat material, but also, provide enhancements in fit, function and overall appeal. As can be appreciated, the design and manufacturing of a seat cover must reasonably accommodate different seats of different automobile manufacturers. In the automotive market, where design, fit and function of automotive interiors is very competitive, the designer of a protective seat cover is faced with a unique set of challenges. Not only must the seat cover provide a custom fit that appears taut and wrinkle free, it must also provide a number of other benefits to the end user such as comfort, durability, dirt and stain resistance as well as additional benefits such as flame resistant and easy to install just to name a few. These traits are particularly important if a seat cover provider wants to stay competitive in this very competitive market.

Various manufacturers of seat covers provide different solutions to these challenges with a number of these solutions being embodied in the patent literature i.e. U.S. Pat. Nos. 5,785,381; 5,403,066; 5,028,472; 4,669,779; 4,396,227.

U.S. Pat. No. 5,785,381—Seat Protector—This patent describes and claims a flexible seat cover consisting of a 12 inch piece of 6 to 8 ounce construction of vegetable tanned leather. While this invention may be durable it does not provide seat protection to the entire seat back and entire seat bottom. This invention only provides about 12 inches of protection for the seat back. Unlike custom fit seat covers that encompass the entire seat back and bottom, this invention has the potential for catching utility belt components on the upper edges of this design while entering the vehicle. Tanned leather does not absorb perspiration well and must be custom molded for each specific seat design to conform to a multitude of seat shapes to avoid tenting and slipping over the seat.

U.S. Pat. No. 5,403,066—Vehicle Seat Cover—This patent describes and claims a terry cloth seat cover for improved comfort. A Terry cloth outer shell does provide some potential comfort thru heat reduction and perspiration reduction benefits, however, a Terry cloth seat covering is not durable for commercial applications and is often less durable than the original manufacturer's seat covering. This universal design to accommodate most seats by incorporating bungee cords and rods as a means of a fastening system is cumbersome and does not always allow for a form fitting look. As most original manufacturer's seats are all unique in their design and structure, it is often difficult if not impossible to create a truly “universal” fastening system.

U.S. Pat. No. 5,028,472—Fastening Means for Custom-Fit Seat Covers—This patent describes and claims a relatively inelastic soft, but durable material that is custom cut and made into covers for vehicles. There is a separate cover for the seat back as well as the seat bottom and each cover is held fast by pulling a pile fastening hook portion (Velcro) into position and pressing it directly into the seat cover material having a loop pile construction, eliminating a need to sew the loop pile fastening portion to the cover fabric. This design incorporates Velcro straps that are connected as a means to fasten and adjust the seat cover over the life of the product. Shortcomings are that it requires the top seat cover to fully encapsulate the seat in order for the Velcro straps to be connected. The Velcro straps must be routed under the seat structure. This is at times, depending on the seat structure, difficult to do this and still avoid contacting or interfering with the mechanisms and controls located under the seat, especially as the seat is being adjusted. As most original manufacturer's seats are all unique in their design and structure, it is often difficult if not impossible to create a truly “universal” fastening system.

U.S. Pat. No. 4,669,779—Seat Cover—This patent describes and claims a one piece cover that fully encapsulates the seat back component and provides flexibility from a multi-dimensional stretch material. This material covers the seat back storage pocket and potentially eliminates the use of this option and the benefits it provides. This option must then be added to the seat covering. The seat bottom fastening mechanisms must be routed under the seat structure and is sometimes difficult to do this and still avoid contacting or interfering with the mechanisms and controls located under the seat, especially as the seat is being adjusted. It is also claimed in this invention that this single seat covering design will adapt to seats of different sizes and shapes while still retaining a custom tailored appearance. The problems of securing such a seat cover are well known in the industry and include the difficulty of supporting the cover against forces such as the force of pulling the cover downward as the occupant sits in the seat. This can result in significant pressure and strain in a downward direction on the seat back. It is well understood in the art of seat coverings that the only way to really achieve a custom tailored look and avoid issues with wrinkling, tenting, scrubbing and stresses from shifting is to custom cut and sew individual panels that conforms to the original seat design. The seat described in this invention is of simple design and structure and is not typically representative of modern seat designs in today's vehicles that include multiple panels at compounding angle to one another. This invention also embodies the use of multiple straps, hooks and anchors as a means to fasten the covering thereby making it more complex to install.

U.S. Pat. No. 4,396,227—Car Seat Covers—This invention describes and claims a seat covering made of sheep skin and wool attached thereto and including fitting means making it suitable for universal fitting to a variety of different sizes of seats and including appropriately located sleeves and fixed attachments for cords resiliently connected thereto to provide holding for the cover on a car seat. The seat bottom and seat back fastening mechanisms must be routed under the seat and attached to the seat frame structure with the use of hooks that are attached to the seat framework structure. The location of these structures can vary from seat to seat requiring specific adjustments for each seat type. It is also claimed in this invention that this single seat covering design will adapt to seats of different sizes and shapes while still retaining a custom tailored appearance. It is well understood in the art of seat covering that the only way to really achieve a custom tailored look and avoid issues with wrinkling, tenting, scrubbing and shifting is to custom cut and sew individual panels that mimics and conform to the original seat design. The sheep skin and wool components of this design do not provide the same level of comfort, heat absorbing qualities, desired appearance and is not particularly resistant to dirt and grease accumulation.

### SUMMARY OF INVENTION

Primary object of this invention is to provide a custom fit, durable flame resistant seat covers that will overcome the short comings of the prior art devices. It is another object of the present invention to provide a custom fit, durable flame resistant seat cover for passenger vehicles. Another object of this device is the provide a custom fit, durable flame resistant seat cover for the interior of vehicles that meets all federal motor vehicle safety standards and NHTSA standard # 302—Flammability of interior materials.

Another object of the present invention is to proved a custom fit, durable flame resistant seat cover than when properly installed will cover entire section of seat back and the entire section of seat bottom for the interior of automobiles and other passenger type vehicles. Another object of the present invention is to proved a custom fit, durable flame resistant seat cover constructed from a Kevlar®/Nomex® blend of material commonly used in firefighting garment and is proven to delay the onset of ignition and retards involvement of the OEM seat material and foam core in a thermal event.

As understood by one having ordinary skill in the art, Kevlar® is a para-aramid synthetic fiber, and Nomex® is a meta-aramid synthetic fiber.

It is another object of the present invention to provide a custom fit durable high wear resistant seat cover consisting of dual layer Kevlar®/Nomex® blend material construction in high wear areas. Particularly the side panels or seat bolster panels of the vehicle seat.

It is another object of the present invention to provide specific features of the seat covers manufacturing and fastening scheme so as to be universal in installation and still provide a custom fit and look to the cover.

It is another object of the present invention to provide accessory pockets sewn into seat cover side panels for installing but not limited to flashlights, notepads, writing instruments just to name a few. It is another object of the present invention to provide a seat cover that is simple and easy to install and remove by the customer.

It is another object of the present invention to provide a seat cover that is feasible and economical to manufacture.

It is another object of this invention to provide a seat cover made from 50% Military grade filament Kevlar® and 50% Nomex® fiber materials (both are trademarks of E. I. DuPont de Nemours & Co., Inc.) specifically manufactured and woven to form Armor 7.0® (a trademark of Safety Components Fabrics Technologies, Inc.), providing a durable seat cover with an initial tensile strength of 550 lbs and tear strength of 84 lbs initial use. It is another object of this invention to provide a flame resistant seat cover that meets the Federal Vehicle Safety Standard Guidelines, specifically Standard No. 302—Flammability of Interior Materials—Passenger cars, Multipurpose Passenger Vehicles, Trucks, and Buses for application and use.

It is another object of this invention to provide a custom fit seat cover that is durable, flame resistant and comfortable for the occupant. These specialized materials have natural low heat absorbing properties providing a comfortable and cool environment for the occupant when compared against higher heat absorbing materials.

The objects and many of the attendant advantages of this invention will be readily appreciated as the same becomes better understood by reference to the following detailed description when considered in conjunction with the accompanying drawings wherein:

### BRIEF DESCRIPTION OF THE DRAWINGS

FIG. 1 is a multi-dimensional perspective of an automobile seat with the seat covering of the present invention installed and including utility pockets;

FIG. 2 is a multi-dimensional perspective of the rear seat back panels and construction providing a custom manner of securing seat covering thereby accomplishing a custom fit, ease of installation and a desired appearance; and

FIG. 3a and FIG. 3b is a sectional perspective showing details of the construction the hold down straps and fastening means in the installed position.

### DETAILED DESCRIPTION OF THE PREFERRED EMBODIMENT

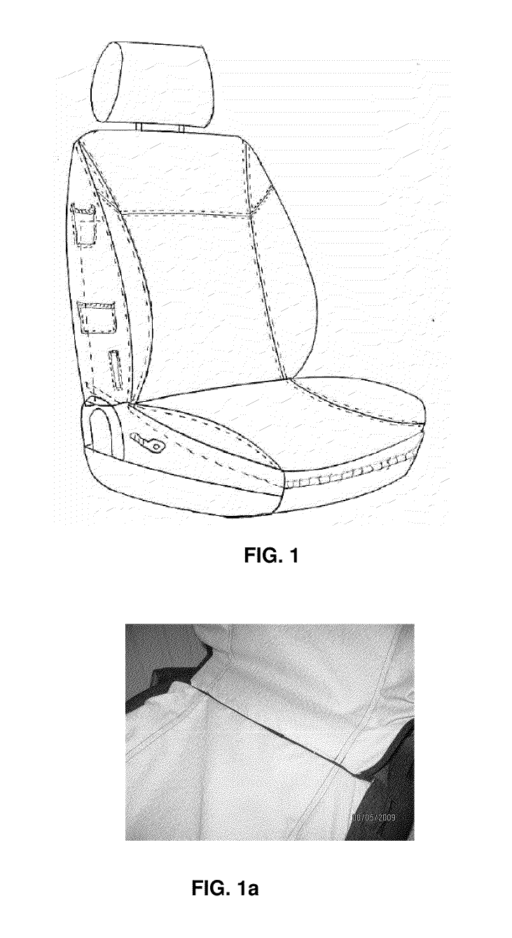

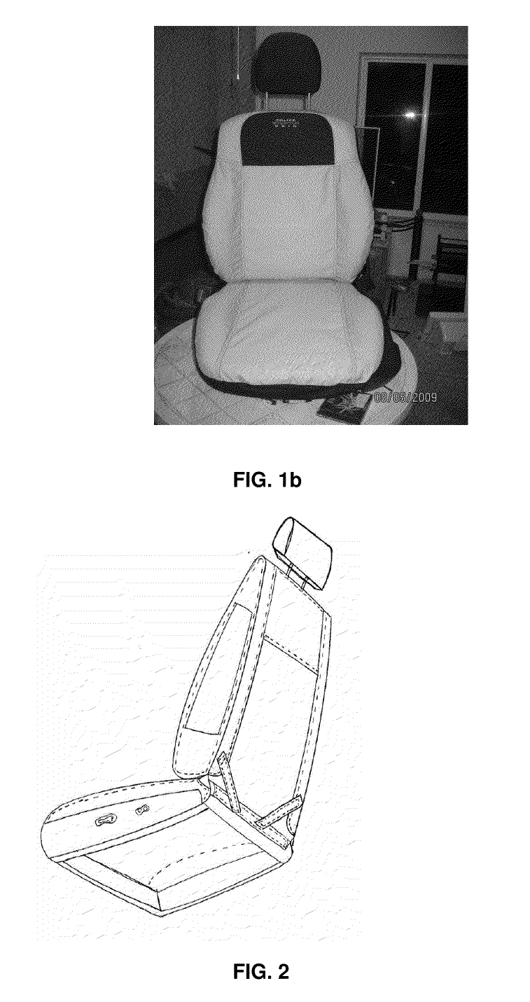

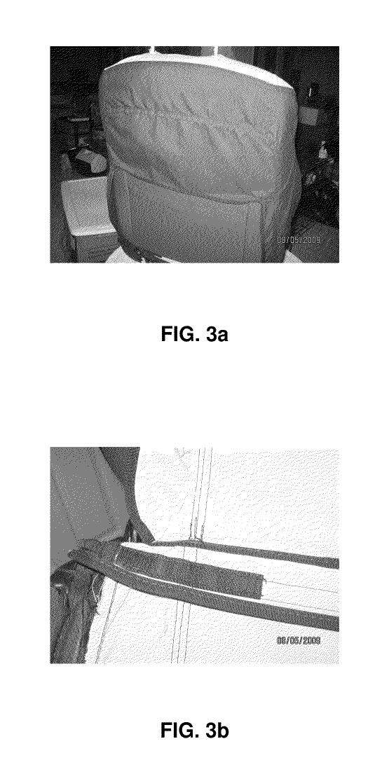

Referring now to the drawings, and in particular FIG. 1, the present invention is shown generally comprising a seat cover and FIG. 2, showing the seat cover construction on the opposite side of the seat back portion, FIG. 3a, showing the top rear section of the cover construction detailing construction thereof and FIG. 3b, showing the seat cover rear bottom detailing construction of the fastening means, are all used in conjunction with each other to accomplish the invention.

The seat cover FIG. 1 and FIG. 2 includes a 50% Military grade filament Kevlar® and 50% Nomex® fiber materials (both are trademarks of E. I. DuPont de Nemours & Co., Inc.) specifically manufactured and woven to form Armor 7.0® (a trademark of Safety Components Fabrics Technologies, Inc.), that is threadably attached by sewing the individual panels to form the unique one piece construction in FIG. 1a for ease of assembly. The side bolster panel FIG. 1 and FIG. 1a consists of a dual layer of material providing comfort outstanding durability and wear resistances. FIG. 1 also shows the accessory pockets sewn into seat cover side panels for installing but not limited to flash lights, notepads, writing instruments, etc. . . . FIG. 1a shows the lower lateral edge of the back panel is sewn together with the top portion of the lateral edge of the bottom panel of the seat cover shown in FIG. 1a and FIG. 3b and incorporates a flap section FIG. 3b that feeds between the top and bottom section of the original seat. FIG. 3a shows the top rear construction sewn together in panels forming the unique construction allowing the cover to contour the original seat geometry and preventing the cover from shifting, tenting, and sliding. FIG. 3a also shows the unique back support panels vertically transcending the back vertical edge of the original seat and sewn to the cover side panels providing additional and unique support structure for the cover. FIG. 3b shows unique fastening means to secure the cover in place and is accomplished by using Velcro® straps sewn into the bottom portion of the vertical support panels and is sewn into and across the apex of the bottom of the support panels FIG. 2 at about 45 degrees and attached to the lateral portion of the seat flap FIG. 3b. This in combination with all the previously describes features accomplishes the unique structure and fastening means of this invention.

### Operation of Invention—

To use of the Durable Flame Resistant Seat Cover FIG. 1 and FIG. 2, the following steps should be taken:
1. Slip seat cover over top of seat FIG. 1 and then slip seat cover over bottom of seat FIG. 1a while properly aligning the panels of the cover into position.
2. Maneuver the original seat to its most forward position and tilt the back of the seat to its most forward position as well.
3. Slip the seat flap FIG. 3b between the top and bottom sections of the original seat and pull flap thru to back rear section of original seat as shown in FIG. 2.
4. Pull flap to desired snugness thereby accomplishing a custom fitted look across the seat bottom and seat back as shown in FIG. 1b—Photograph of invention prototype.
5. Pull fastening straps securely across apex of the bottom of the support panels FIG. 2 at about 45 degrees and attached to the lateral portion of the seat flap FIG. 3b section for a robust and secure attachment scheme.

This in combination with all the previously describes features accomplishes the custom appearance, unique structure and unique fastening means of this invention.

It will be understood that each of the elements described above, or two or more together may also find a useful application in other types of methods differing from the type described above.

While the foregoing written description of the invention enables one of ordinary skill to make and use what is considered presently to be the best mode thereof, those of ordinary skill will understand and appreciate the existence of variations, combinations, substitutions, and equivalents of the specific embodiment, method, and example herein. The invention should therefore not be limited by the above described embodiment, method, and examples, but by all embodiments and methods within the scope and spirit of the invention as claimed.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

The instant invention has been shown and described herein in what is considered to be the most practical and preferred embodiment. It should be recognized, however, that departures may be made within the scope of the invention and that obvious modifications will occur to a person skilled in the art.

What is claimed is:

1. A seat cover kit for covering and protecting a seat comprising:
a backrest cover;
a seat cover;
means for removably securing the backrest cover and the seat cover over the seat; and
wherein the backrest cover and the seat cover each are formed from a material comprising a para-aramid synthetic fiber and a meta-aramid synthetic fiber.
